(19) United States
(12) Patent Application Publication
(10) Pub. No.: US 2003/0105887 A1
(43) Pub. Date: Jun. 5, 2003

(54) Method and system for integration of software applications

(76) Inventors: Burke David Cox, Fairfax, VA (US); Doug Matthew Crane, Alexandria, VA (US)

Correspondence Address: Kevin A. Buford, Esq., Holland & Knight LLP, Suite 700, 1600 Tysons Boulevard, McLean, VA, 22102-4868, US

(21) Appl. No.: 10/246,375

(22) Filed: Sep. 18, 2002

Related U.S. Application Data
(63) Continuation-in-part of application No. 09/997,942, filed on Dec. 3, 2001.

(51) Int. Cl. G06F 9/00

(52) U.S. Cl. 709/328

(57) ABSTRACT

An integration server includes a predefined, fixed system API that pre-defines the low level interfaces between software applications. The process for integrating these application programs comprises initializing an integration administrator; defining operations and operation resources for transactions between a client and target application programs; configuring an integration server to accept transactions from the client application program via client code and from the target application via a solution server code; configuring the client code consistent with a client application interface and a predetermined integration server API, and solution server code consistent with a target application interface and the integration server API; and deploying the client code and solution server code. In operation, client code creates an operation object including at least one dataset at a first program using a predetermined integration API; submits the operation object to an integration server; processes the operation object to create a further request object including said dataset, and forwards the request object to a solution program; and processes the request object by the solution program to extract the dataset, forward the dataset for processing at a second program according to functionality associated the operation object, and return a response.

### RELATED APPLICATIONS

This application is related (a) as a continuation in part to U.S. application Ser. No. 09/997,942, filed on Dec. 13, 2001, and (b) as a non-provisional application continuing in part from U.S. provisional application no. ______, entitled Method and System for Integration of Software Applications filed on Sep. 16, 2002, and by the same inventor as this application, both of which applications are fully incorporated herein by reference for all purposes.

### FIELD OF THE INVENTION

The invention in general relates to systems for integrating multiple other systems, and more particularly to a system for integrating multiple software applications together and with other systems to permit the exchange of data between software applications and users.

### BACKGROUND

As computers have grown more powerful, so too has the rich variety of available application and networking solutions. While taken separately each new application represents a step forward, their greatest potential lies in the promise of leveraging all the information available when all the applications of an organization are working together. Simply sharing data between software systems is not enough, when compared to the potential offered by seamless integration of business data and processes.

However, accessing the data within disparate systems can be a considerable challenge. Companies utilize a complex combination of computer hardware, operating systems, and data formats. These systems may be dispersed around an office, a campus, or around the globe, requiring a host of different technologies to be used to connect and integrate them.

The biggest hurdle to successfully integrating business systems is often the technology itself. Mastery of complex concepts such as networking and distributed object protocols, data encryption, and user authentication are necessary to properly design and implement an integration solution. Learning to utilize the products that traditionally provide these kinds of services (e.g., as offered by BEA WebLogic Server, IBM WebSphere, Microsoft BizTalk, webMethods EAI, and the like) is itself a time-consuming and expensive proposition.

FIG. 1 illustrates a typical approach used today for integration of distributed applications. In this case, newer ERP (enterprise resource planning) and CRM (customer relations management) applications 11 and 12 are being integrated together with legacy applications 13 in an enterprise network 10. To achieve this integration, APIs (application programming interface) 15 are created between each of these applications 11-13 by means of an enterprise application integration (EAI) server 14. In other words, the API of each of application is connected to the API calls from the other back-end applications 11-13. In doing so, the various application APIs 15 are typically written in a manner that is tailored for the particular connections and data transfers anticipated at the time of programming, and are further exposed (e.g., published) in order to allow access and use of the various applications.

There are a number of problems with this approach towards integration. First, it is time consuming and expensive, often focusing substantial development effort on a needless re-engineering of well-known problems and services. This is needless because there are common traits to most integration projects, which, if removed from the scope of the project, can dramatically reduce the cost of implementation. When considering a developer's skill set in the context of an integration project, much of the emphasis has traditionally been placed on skills pertaining to “enterprise technologies.” Concepts such as guaranteed messaging, remote method invocation, distributed object protocols, wire protocols, transactions, data encryption, and resource pooling are all examples of enterprise technologies. What many businesses forget is that these skills have little to do with their integration needs. When a business considers an integration solution, it is because they have data that they need to access, change, present, or otherwise manipulate. If a company has the necessary skills in-house to effectively work with these enterprise technologies, there can be no doubt that the project would be better off applying those resources to the business-specific components of the project. However, these components often end up as secondary priorities when dealing with the complexities of the typical approach to integration.

Beyond this undesirable allocation of resources, the typical integration project also achieves the interconnection of applications by writing custom API code. While this may initially seem like the easiest way for a programmer to insure that, say the ERP application is receiving and responding with the right calls from the CRM application, this also creates a “co-dependent” set of applications. If one of these applications is upgraded or replaced, the API code for both applications (and other applications impacted by any changes) may need to be modified. The initial API code in an enterprise integration project is complex enough, but over time it may get too unwieldy to adequately maintain. This situation is only made worse by the reality that few developers for integration projects do a good job of documenting the spaghetti-like maze of API connections, leaving future programmers with the additional task of trying to decipher what was done and why in past integration efforts.

Most integration is also achieved by exposing the API calls from each of the systems being integrated. This is a growing concern by many companies, since the exposed APIs inherently mean that someone trying to break-in or attack a network has more opportunities to do so.

Another problem with traditional integration projects revolves around the issue of transport. The actual transport of data and intended business operations from one system to another (or many systems) can be a challenge for communicating between different software applications. In response, many companies are now turning to internet web services as a possible solution. But, the approach typically taken by web services is to uniquely serialize Application Programming Interfaces (APIs) to an XML data stream, thus extending back end API function calls to the Internet.

Several problems still remain with these new web services. First, the direct publication of API libraries still result in tightly bound software solutions, where client applications are aware of and dependent on implementation details of specific server software. Second, programmatic APIs still tend to address finer implementation touch-points than needed for an integration solution, continuing to focus development efforts away from the business reasons for integration. Third, to implement a new web-service based transport of an operation, specific serialization code for a particular functional API must be created. This code can be extraordinarily complex, especially in the case of transport between differing technologies (for instance, a Microsoft-based Visual Basic SOAP client invoking a Sun-based Java operation).

On the other hand, if one could eliminate the redundant elements of integration from a project, implementation speed and cost can be dramatically enhanced. This is even more compelling for companies that do not have the development expertise to take on a project involving enterprise technologies. If one could make it easier to keep an integration project in-house, it becomes easier to apply one's true business experts, the individuals that know one's company and how one's business works, to achieve the best integration solution. Just such a solution to the problems noted above and more, is made possible by our invention.

### SUMMARY

An illustrative summary of my invention, with particular reference to the detailed embodiment described below, includes an integration server comprising a fixed system API that pre-defines the low level interfaces between software applications. This permits the implementation of a more loosely connected and more independent group of applications following integration, as well as the employment of a defined, reusable methodology for more rapidly deploying an integration solution without linking together the individual application APIs. This includes, for example, a method and system for operating transactions between programs having different APIs which are at least partially incompatible, by: creating an operation object including at least one dataset at a first program using a predetermined integration API; submitting the operation object to an integration server; processing the operation object to create a further request object including said dataset, and forwarding the request object to a solution program; and processing the request object by the solution program to extract the dataset and forward the dataset for processing at a second program according to functionality associated the operation object. The integration code used in facilitating integration of these plural application programs, each with different APIs, comprises a set of predetermined and fixed processes operable as a common API between these applications. The process for integrating these application programs comprises initializing an integration administrator; defining operations and operation resources for transactions between a client and target application programs; configuring an integration server to accept transactions from the client application program via client code and from the target application via a solution server code; configuring the client code consistent with a client application interface and a predetermined integration server API, and solution server code consistent with a target application interface and the integration server API; and deploying the client code and solution server code.

### THE FIGURES

The invention may be more readily appreciated from the following detailed description, when read in conjunction with the accompanying drawings, in which:

FIG. 1 illustrates a typical approach to integration prior to the invention.

FIG. 2 illustrates a system employing a business integration server according to a first embodiment of the invention.

FIG. 3 is a block diagram illustrating another system employing a business integration server according to an embodiment of the invention.

FIG. 4 is a block diagram illustrating a high-level overview of an implementation process implemented by a business integration server according to an embodiment of the invention.

FIG. 5 is a block diagram illustrating another integration implementation using a business integration server according to an embodiment of the invention.

FIG. 6 is a block diagram illustrating at a high-level the operation of a system employing a business integration server according to an embodiment of the invention.

FIGS. 7A through 7E illustrate at a lower level the data flow for the embodiment illustrated by FIG. 6, in which:

FIG. 7A illustrates the inbound process from the client code;

FIG. 7B illustrates the inbound process from the integration server;

FIG. 7C illustrates the inbound process from the solution server and solution code, and back to the solution server;

FIG. 7D illustrates the outbound process from the solution server;

FIG. 7E illustrates the outbound process from the integration server and client code to the client entity.

### DETAILED DESCRIPTION OF AN EMBODIMENT OF THE INVENTION

The Business Integration System (BIS) according to our invention, described here in detail in connection with a presently preferred embodiment of the invention, provides a rapid environment for introducing an integration architecture into an organization. It is preferably a self-contained, portable and scalable software solution that automates many of the more difficult challenges of application integration. BIS was designed with an evolving organization in mind, where access to development documentation, integration lifecycle information and the status of deployed integration solutions may be securely provided via networks such as the Internet. Any authorized developer, manager or executive may thereby determine how the organization's software systems are interconnected and how well those connections are working. BIS accomplishes this by solving important objectives of integration—definition, development, deployment, flexibility, security, administration and maintenance—with a sophisticated architecture that completes the integration solution quickly. The development tools, software server, and connection code all support a methodology that enables the connection of both data and business processes without the complexity or risk of linking together Application Programming Interfaces (APIs). The unique methodology and technology of BIS, captured in a unique software architecture, enables flexible and rapid software integration, reduces development risk and prevents the creation of “spaghetti-code” connections between software applications.

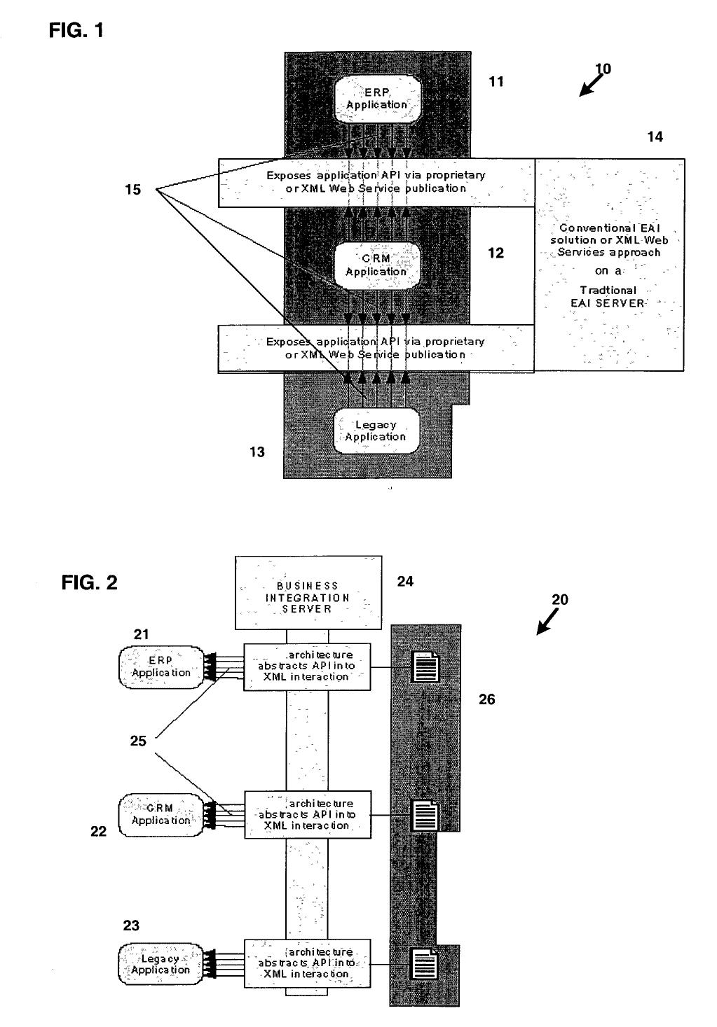

This preferred embodiment of the invention may be better understood by reference to FIG. 2. Unlike the approach of FIG. 1, each of the applications 21-23 of BIS 20 communicates with an Integration Server 24 via a fixed-system set of APIs 25. These APIs pre-define the low level interfaces, preferably based on XML interactions, between software applications 21-23 and other entities via the Integration Server 24. As job requests 26 are received, the requests are made to the Integration Server 24. The Integration Server in turn provides a well-formed call, via the fixed API 25, to the server for the targeted application. In doing so the APIs of each application are not exposed, since the entities making requests 26 only know the API for making requests on the Integration Server 24. Because the Integration Server APIs are fixed, preferably as XML transactions, an integration solution can be rapidly deployed across an organization, and rapidly modified as new or revised application code is rolled out.

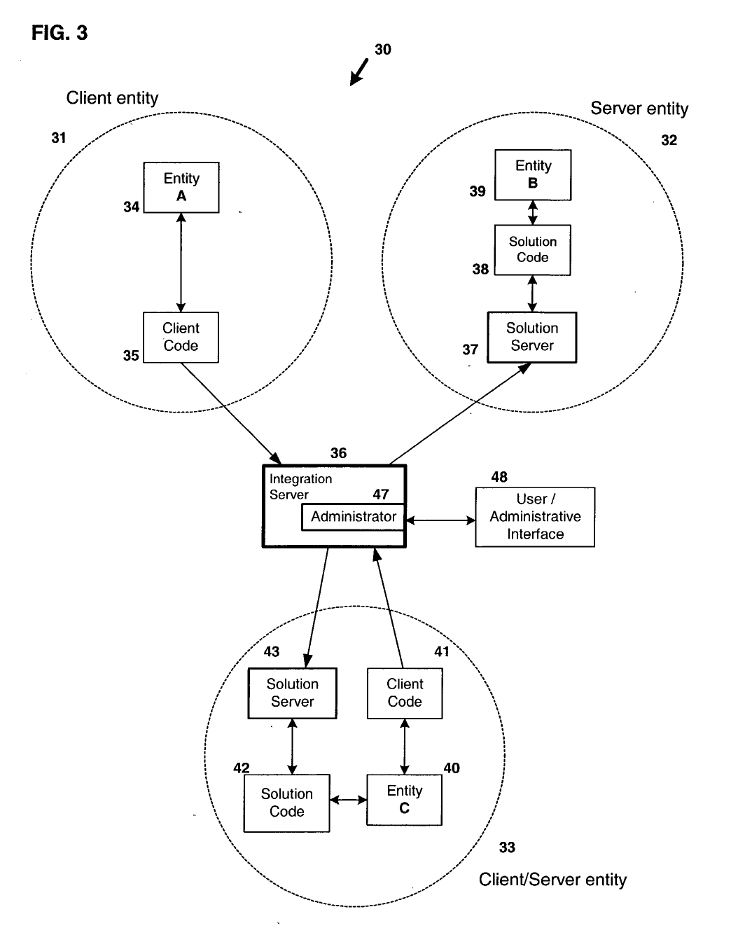

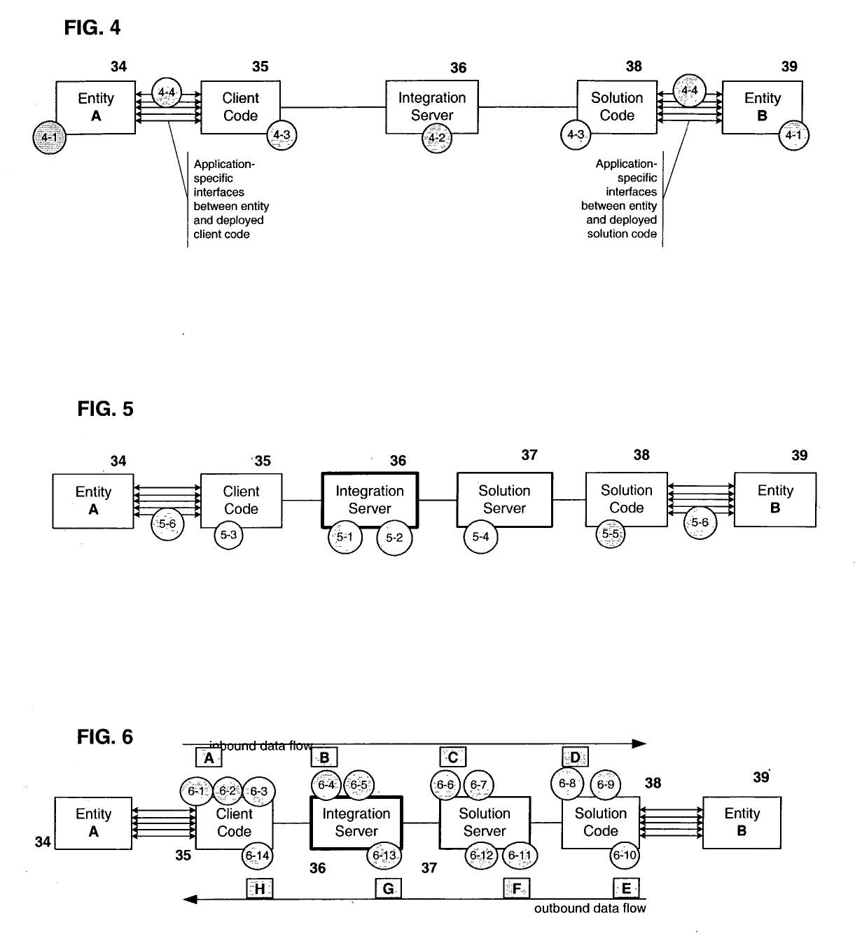

FIG. 3 shows yet another alternative for deployment of the BIS architecture. While the BIS is described herein in connection with transactions between two entities, the client and server relationships of these entities can be aggregated across multiple entities 31-33. This results in an enterprise integration where various heterogeneous entities act as clients 31 (with entity 34 and client code 35), servers 32 (with entity 39, code 38 and server 37), or both 33 (having server 43 and solution code 42, in addition to client code 41, between the entity 40 and integration server 36). Some of the more prominent features of the BIS architecture are described in the next paragraphs, followed by the operational examples of FIGS. 4-7.

Advanced Integration Methodology (AIM): The integration-centric nature of this preferred BIS architecture is a significant aspect of the technology. Where other approaches sometimes fail to distinguish between distributed application development and application integration, the BIS architecture focuses on application integration and guides a development team towards a well-executed, loosely coupled, scalable, secure, and flexible integration solution.

To begin with, a solution using the BIS architecture preferably starts with modeling the data and business processes in a platform independent format such as XML. By using XML documents as the known mechanism for data interchange within the integration server framework, specific, potentially platform-dependent, interfaces can be published to clients of the integration server framework. Thus, modeling the data and defining the business processes may drive the solution forward. This approach differs from that of most web-services which take existing models of data and processes and push them out to the Internet.

Next, the BIS uses a fixed system API that pre-defines the low level interfaces between software applications. Since practically every server architecture has some native support for XML, and XML is nearly universally accepted as the way that data is, or will be, exchanged, the fixed API preferably uses an XML interaction (see illustrative classes discussed below in connection with FIG. 5. However, simply modeling the data that needs to be exchanged is much different than modeling both the data and business processes that are implemented across the Internet divide. BIS′ unique approach of a fixed API allows native code to be deployed for differing operating environments without the future burden of new interface serialization technologies. Having a known API of as few as two dozen or even less functions gives BIS the technology advantage for adding and maintaining value-added support for administrative capabilities, platform deployment options, enhanced monitoring and tracking tools, greater security, and other enterprise software capabilities that are dependent on getting the state or condition of known object types.

This fixed API adds another significant benefit to an integrated solution: the abstraction of back-end application interfaces. One of the primary problems of using distributed application techniques for addressing integration issues is that an organization introduces the known risks of interface lifecycles to their external partnerships. Thus, changes that may appear to simply affect internal resources (e.g., migrating to a new database platform, normalizing data structures, unifying coding style) now suddenly affect the IT solutions of partners, customers and/or government agencies. Because a BIS methodology abstracts specific system implementation details, changes—whether minor or wholesale—are better isolated from users of the integrated solution.

This abstraction of business processes can also lead to another benefit: security. Not only does having access to function-level methods increase complexity and interdependency, it also introduces the potential that partners, customers and others might attempt to use those methods in an unintended manner. Developing programmatic mechanisms to ensure that specific methods are called in the appropriate order and by appropriate users is a significant challenge of prior distributed application development approaches. The BIS architecture isolates the called methods from the caller, via the fixed system API. Thus, all integration requests are preferably encapsulated in XML documents (which are, by definition, non-executable in nature). This, “pass through” from executable code, to XML, and back to executable code creates the equivalent of an integration server firewall that allows specific requests to be examined in text and potentially blocked or modified before passing the request for action to any back-end server application.

Distributed/Scalable Architecture: A key component to the preferred BIS architecture is the integration server. This server helps address such issues as scalability, flexibility and functional distribution. By means of a loosely coupled connection to its constituent components, numerous configurations may be created to address specific deployment needs. Configured with all components “in process,” BIS consumes fewer resources and can easily be deployed alongside other applications on an existing computer server. For larger enterprises with greater integration demands, each component can be hosted on an independent computer system for maximized performance, greater fault-tolerance and the like.

In addition to the integration server, other integration components may be combined (preferably as loosely coupled) to provide full life-cycle management of integration solutions. Whether a particular integration need demands point-to-point, broadcast, or publish/subscribe capabilities, the BIS can be used to deliver the integration architecture, client components and back-office deployment capabilities necessary for its implementation. Examples of other integration components that may be advantageously used in the BIS architecture include:

Client connectors: Every integration request must start somewhere. The BIS preferably enables those requests to be created, encrypted, authenticated and transported with a deployable unit of code called the “client code” or “client connector.” This code is preferably implemented on the Sun© Java platform with specialized, freely-distributable Java packages. For the Microsoft© Windows platform, similar capabilities are available for both the NET and traditional Windows technologies—natively compiled for the Microsoft Visual C++, VisualBasic, and C# languages. Those skilled in the art will recognize that other implementations may be used to achieve the same result. Further, these distributed client capabilities need not be bound to a “per-user” license agreement. Rather, they may be freely leveraged by business partners or internal resources to gain immediate access to published integration capabilities.

Pluggable server components: Functional components may also be included in the BIS environment to support extremely flexible development and deployment capabilities out-of-the-box. All major server components are preferably extensible or completely overridable, allowing for specific enhancement by BIS customers. For instance, if an organization uses a unique authentication mechanism, the entire BIS Authentication Layer can be customized on an integration operation basis. The flexible nature of such a pluggable server component architecture is described further below.

Provider Host: Just as every integration request must start somewhere, the provider host (also referred to as a solution server) gives each request a place to go. These named components define targets for every integration operation defined in an organization. Again, BIS provides a platform-independent executable for use in connecting back-end software applications to the integration server. The provider host differs from the client connector, though, in that it may act as a mini-server. It preferably queues integration requests, manages resource accessibility and provides a structured mechanism for guaranteed integration request delivery by maintaining a two-way connection with the BIS server.

Provider: Once a provider host receives a request and moves it from its internal queue, some programmatic functionality should be executed against the data and business processes defined within that integration request. That code is contained in providers (also referred to as solution code). Each provider is preferably a finite, instantiable module of executable software code that knows how to accurately process a specific integration request. The BIS preferably provides pre-packaged providers for common integration efforts such as relational database interaction, XML data transformation, ASCII report parsing, request routing and publish/subscribe capabilities. BIS′ generated code encapsulation allows code to be generated in various formats for quick implementation of custom providers to leverage business logic from new or legacy applications.

BIS is preferably implemented without the need for a client installation (a zero-client-install environment), thus allowing a quicker, simpler introduction of a sophisticated enterprise architecture than other integration approaches permit. This is preferred, as a successful integration architecture should do more than simply overcome the technology barriers that prevent the communication between disparate software applications. Integration, by itself, can be a complex and confusing endeavor. Introducing a complex and confusing “solution” can quickly impede any potential project aimed at introducing a formal architecture into the enterprise. The human factor cannot be ignored when selecting an integration framework. Whether installed on a dedicated server computer, or alongside a developer's other software applications on a desktop system, the BIS environment may thus be set up to automatically “serve” all interested parties via a built-in (e.g., HTTP) web server. Every interface and capability may thus be accessible to any authorized developer, manager or business executive with a web browser. This immediate, unobtrusive ability to deploy the BIS software enables every constituency within an organization to quickly evaluate and experience the capabilities of BIS solution with no impact on currently executing applications or established development environments.

User interface served by integration framework: The built-in web server employed by the BIS can be used to publish the entire user-interface for the BIS environment:

the help system, testing interface, development and deployment environment, reporting and server configuration, all of which may be made immediately accessible to authorized users. For corporate organizations, this means every integration solution may always be accessible to internal business and technical experts no matter where they are: in the office, on the road, or on vacation, as accessible to authorized users as any common Internet connection.

Self-contained integration environment: BIS can be a completely self-contained software solution. Although it can leverage existing corporate resources for database, application server and web publishing services, it need not require any additional software infrastructure for deployment. These other services can represent significant hidden costs in competitive products, and the requirement for an additional application server—often a specific application server—can represent a substantial increase to solution cost and reduction on one's return on investment. An additional advantage of these self-contained features of BIS is that it can be easily installed in a matter of minutes. By using a self-guided environment for integrating systems, effective enterprise-capable solutions can be deployed within an organization in a matter of hours.

The BIS also preferably includes an advanced transaction management feature, allowing an organization to be assured that database-related integration operations are only committed at the right time and in the appropriate order. Flexible options allow for choices regarding operation ordering and phased commits.

Asynchronous/Immediate Commit: For integration jobs that simply require data to arrive at a back-end application and be committed to a data store immediately, this setting ensures it all happens efficiently. This is the “pass-through” approach to integration; upon receiving an integration request the provider host immediately instructs the provider to commit any database changes upon success.

Synchronous/Immediate Commit: If an integration task requires that multiple database operation occur in a certain order, but does not necessarily mandate that each operation complete successfully for committal to the database, the synchronous/immediate commit setting is appropriate. Both immediate commit settings should be used whenever the back-end applications do not support a two-phase commit paradigm.

Asynchronous/Deferred Commit: Some integration tasks affect multiple backend applications. To the outside world, these applications function as one, unified information system. Internally though, these disparate software applications may be absolutely independent. In this case, it may be important that an operation occurs successfully across all these applications before committing information to the relevant databases. But, since they are autonomous systems, the order in which the operations are processed is not relevant. For these cases, the asynchronous/deferred commit setting automatically handles the transactions appropriately.

Synchronous/Deferred Commit: However, given the same scenario as before, with the added caveat that the disparate applications actively share database related information (a customer ID generated in one software application is used as a “foreign key” value in another application), it becomes important that the operations not only happen successfully, but that they happen in the appropriate order. This is the most “strict” setting in the BIS architecture, ensuring that database operations are only submitted to subsequent applications when the previous operation has completely succeeded. Then, the second phase of the commit occurs only after every operation has completed successfully.

Turning now to FIG. 4, a high-level overview of a preferred implementation process using by an integration server is there illustrated. Because of the unique features of the BIS integration server, and in particular the fixed-system API, much of the integration process can now be automated. The basic steps of this preferred process include: identifying the integration need; defining the need; deploying the code; and connecting the entities and code. A more detailed explanation of each step is as follows:

1. Identify the need for entities (applications, data stores, humans) to exchange information (step 4-1): When identifying a need for integration, it helps to recognize that all interfaces (application APIs, direct datastore access, and human interactions) ultimately resolve down to a functional API specific to that interface. These programmatic interfaces identify the “technology touchpoints” where technology may be introduced as a facilitator to improve and automate the processes. To identify the need, at least two entities 34, 39, with identifiable technology touchpoints should be selected. This selection process is preferably expedited for the integration developer by providing a convenient GUI listing of entities for selection.

2. Define the needs identified above with a technology specification stored in a centralized integration server (step 4-2):

a. First, BIS provides the framework (both through the application program and inherent methodology):

(i). Integration needs are preferably indicated with a named interface.

(ii). Integration data is categorized into “inbound” and “outbound” resources that have types.

b. BIS also provides metadata storage and architecture:

(i). The BIS integration server 36 maintains a metadata repository of defined integration operations.

(ii). The BIS integration server 36 also provides interfaces (application and programmatic) to define and manage integration metadata.

3. Deploy software code (client and solution) necessary to independently implement the technology specification into the BIS (step 4-3): This code preferably includes:

a. Client code 35 (both library dependencies and need-specific generated code):

(i). Implementing connectivity to server.

(ii). Facilitating creation of requests.

(iii). Managing submission lifetime.

b. Solution server 37 (e.g., an executable program):

(i). Handling instantiation of solution code.

(ii). Managing processing lifetime.

(iii). Providing connectivity to integration server 36.

c. Solution code 38 (both library functionality and need-specific generated code):

(i). Executing solution-specific functionality.

(ii). Processing a request.

(iii). Creating a response.

4. Connect entities to independent code to employ a full, round-trip solution (step 4-4). Using techniques appropriate for the technology touchpoints, this step implements the final connectivity between the deployed code and the identified entities.

Turning next to FIG. 5, a an alternative, user's view of employing the Business Integration Server (BIS) to solve a specific integration challenge is shown. The use of the BIS environment is there illustrated in connection with the preferred steps of definition, implementation, and actual use.

1. Definition Stage:

a. First, the integration needs are defined as separate “operations” in the integration repository, each “operation” being indicated by a name.

b. Operation data, or “resources” are named as well, and are given a direction (inbound/outbound) and a type (such as XML, .dbf, .txt, etc.).

c. For appropriate resource types, the definition indicates a “schema” that defines the data that is permitted to occur within any resource when the solution is being used.

In the case of the preferred fixed API, the java class “operation” is a collection of datasets that collectively constitute a unit of work to be performed by a provider. (A provider is the implementation of the unit of work; it is hosted by a provider host or solution server and accessed through the Integration Server.) Operation instances are not typically explicitly created; instead, the newOperation( ) method of the Connector class is typically used to create and initialize an operation object. An operation instance contains a series of InputStreams that can be populated by the client for processing. Each stream is contained in an OpResource object, which has a type associated with it and is initialized by the Integration Server in a manner appropriate to that type. Most commonly, these are XML documents; if this is the case, it is possible to interact with the dataset as an object bound to the document schema, alleviating the need to use cumbersome document parsing frameworks. Of course, if use of an API like DOMISAX/etc. is required/preferred, the client is able to interact directly with the data stream. An “OpResource” instance represents a named dataset that is associated with an operation. In addition to a name, each resource has a type (XML, EDI, etc.). When preparing a new operation instance for a client, the Integration Server initializes each resource based on its type and the availability of a schema. Therefore, the initial state of a dataset may be empty, or it may already contain data (for example, a root node in the case of an XML document). When a client holds an operation object that it wishes to populate with data, it must request an OpResource instance by name from the operation and populate the InputStream associated with it. This can be done in two ways: either by interacting directly with the stream instance, or by using classes generated against the resource schema. Regardless of which method is used, it is important to replace the dataset once it is completely populated.

2. Implementation Stage:

a. Define a named “solution server” 37 for the target entity 39.

b. Configure the integration server 36 to acknowledge this solution server 37.

c. Configure the solution server 37 to execute specific solution code 38 upon receipt of an “operation”.

d. Construct and deploy solution code 38 for target connecting to the entity 39 via any appropriate or convenient API.

e. Generate a response.

In the case of the preferred fixed API, the “Connector” class facilitates interaction with an Integration Server. Specifically, all aspects of job creation and management are performed through a connector instance. In order to provide connectivity across the widest range of technologies, such a connector instance hosts an Integration Server proxy object, which in turn implements the transport details necessary to communicate with the server using a particular protocol. The selection of a transport type usually depends on deployment issues. For example, using HTTP or SMTP as a transport will avoid most firewall issues, while using RMI will minimize the resources required for the back end deployment. Other transports will likewise convey similar costs and benefits. The transport type can be specified when the connector is created, or when the connection to the Integration Server is established. Once a connector is created, all transport details may be hidden from the user. The Job class (along with its derivatives Request (=a job submitting operation to the Integration Server) and Response (=a job retrieving processed operations from the Integration Server) and the Operation class provide the framework by which jobs are submitted and retrieved from the Integration Server. An operation is a unit of work that the Integration System performs, and a job is an envelope for any number of operations.

3. Actual Use—A typical interaction with the server might occur like this:

a. Create a connection to the integration server 36.

b. Create an “operation,” populating it with inbound “resources”. This may be done via a newOperation method being invoked to retrieve an initialized operation object, and populating it with data specific to the request.

c. Submit to server 36, indicating named target solution server 37. This preferably occurs via a Request object, the operation being added to the Request object and the request being submitted (e.g., by invoking a processJob method).

d. Handle resulting response (e.g., a Result object).

A simple illustration of the application of BIS to an Integration Solution would be:

1. Run integration server 36 (step 5-1).

2. Configure Operations (step 5-2).

3. Generate client code (step 5-3).

4. Configure and run solution server (step 5-4).

5. Generate solution code (step 5-5).

6. Connect client code and solution code to entities (steps 5-6).

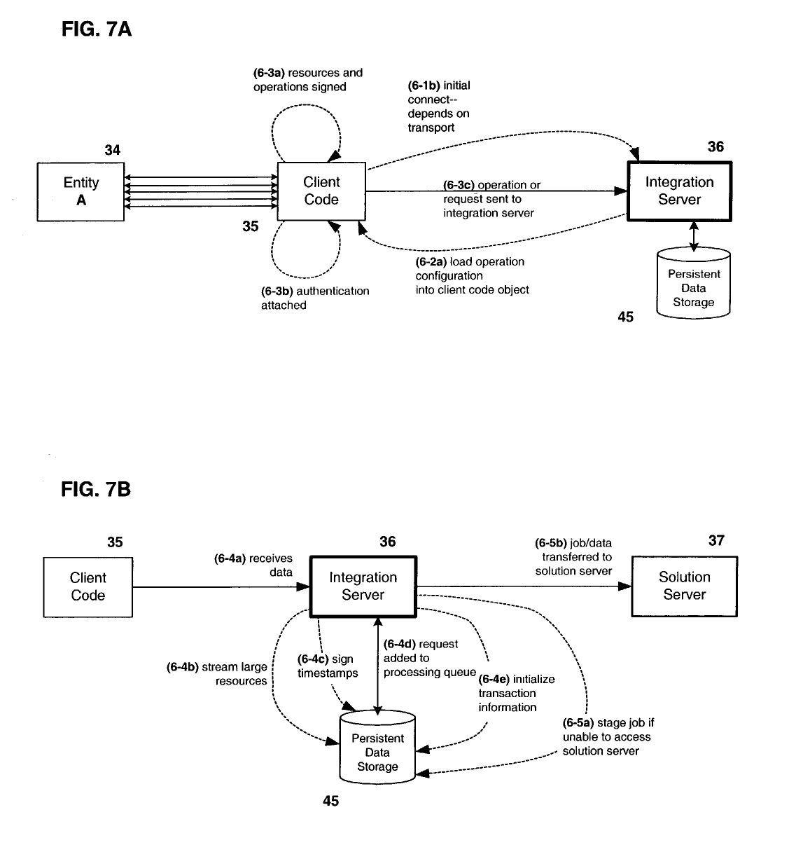

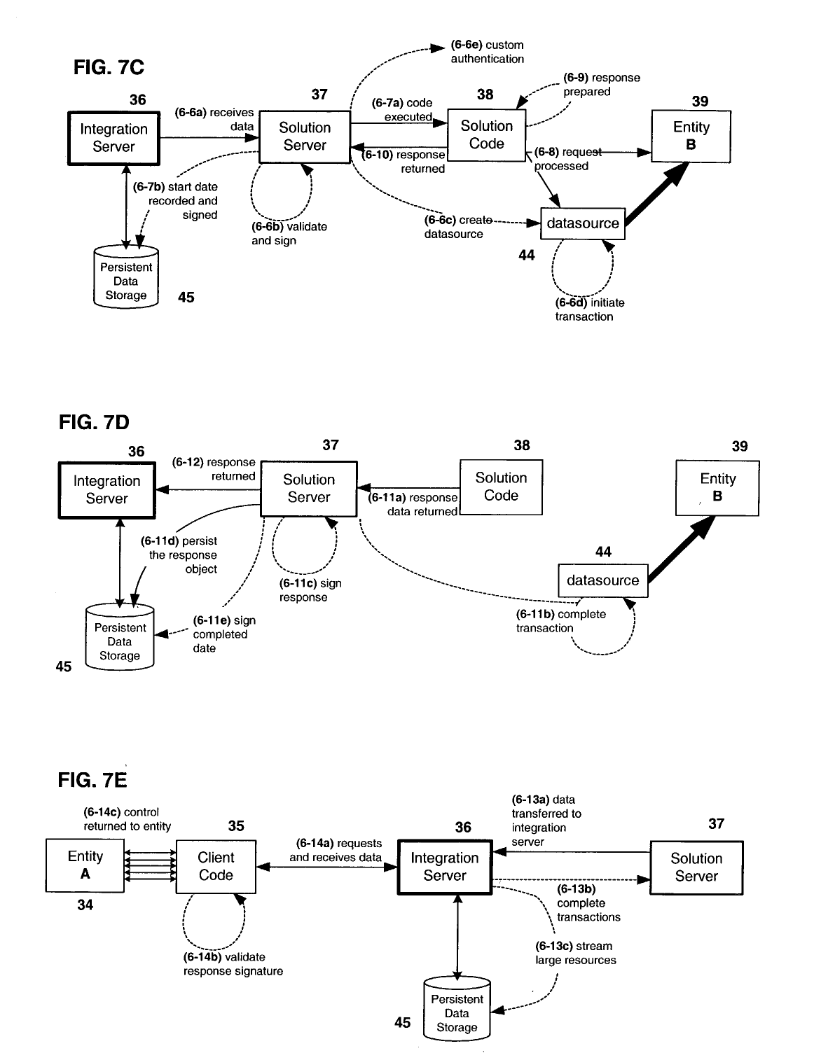

Turning now to FIGS. 6-7, a more detailed view of data flow via the BIS Integration Server when being used by a client user is illustrated. This process includes:

A. FIGS. 6 and 7A—Client code inbound:

Step 6-1: Client code initializes—

6-1a: Connector is constructed (API: language dependent).

6-1b: Transport selected and configured (API: connect( )).

For certain transports, this includes a literal connection to the server.

Step 6-2: Client code constructs operation—

6-2a: Server based construction (optional).

If not used, client manually creates and configures operation object.

API (server based): newOperation( ).

API (manual): new Operation( ), 0 . . . n new OpResource( ),

op.addResource( ), op.requiresSigning( ).

6-2b: Construct “request” and add multiple operations (optional).

If desired, multiple operations can be grouped into a “request” object.

API: new Request( ), rq.addOperation( ), rq.setOperationType( ).

Step 6-3: Client code submits operation

6-3a: Client generates digests for resources and digitally signs,

Generates digest for operations and signs (optional).

Operations can be configured to require signing before submission. If so, this happens automatically during the submission process.

6-3b: Authentication attached (API: parameter to the submit API calls).

Authentication object attached during operation submission.

6-3c: Client streams operation (request) (API: submitJob( ) or processJob( ).

B. FIGS. 6 and 7B—Integration server inbound

Step 6-4: Integration Server receives and logs operation—

6-4a: Receives data and streams in separate thread.

6-4b: Optionally streams to persistent storage.

For large resources, incoming data is streamed to persistent storage to minimize memory usage.

6-4c: Trusted timestamp and signature persisted.

This only occurs for operations and requests that require signing as part of their configuration.

6-4d: Request persisted to the processing queue.

6-4e: All requests initialized with any transaction information.

Step 6-5 Integration Server routes to target solution server—

6-5a: If solution server is inaccessible, stage job for later processing.

6-5b: Job transferred to solution server.

C. FIGS. 6 and 7C—Solution server inbound

Step 6-6: Solution server receives operations—

6-6a: Receives operation data.

6-6b: Validates all signed digests, if present.

6-6c: Datasources created (optional).

6-6d: Transaction initiated (optional).

6-6e: Custom authentication performed (optional).

Step 6-7: Solution server executes solution code—

6-7a: Solution code initialized, configuration loaded, and code executed.

6-7b: Operation start date set and signed (for signed operations).

D. FIGS. 6 and 7D—Solution code inbound/outbound

Step 6-8: Solution code processes request—

Depending on the characteristics of the entity and whether a data source is used, the solution code uses appropriate mechanisms to process the request.

Step 6-9: Solution code prepares response—

Using a combination of generated code and problem specific business rules, a response object is created and populated with appropriate data.

Step 6-10: Solution code returns response—

The response object is returned to the solution server.

E. FIGS. 6 and 7E—Solution server outbound

Step 6-11: Solution server receives response—

6-11a: Receives operation data.

6-11b: Marks the transaction as completed (optional).

6-11c: Sign the response object (if applicable).

6-11d: Persist the response object.

6-11e: Sign the operation completed date (for signed requests).

Step 6-12 Solution server returns response to integration server—

Notifies integration server that request is completed and that data is persisted.

F. FIGS. 6 and 7E—Integration server outbound

Step 6-13: Integration server receives response—

6-13a: Receives data.

6-13b: Transactions across the request (multiple operations) now completed.

6-13c: Optionally streams to persistent storage.

G. Client code outbound

Step 6-14: Client code requests completed transaction—

6-14a: Client receives data in response to request.

6-14b: Validates signature for response.

This only occurs for operations and requests that require signing as part of their configuration.

6-14c: Control returned to entity.

Java-based platform independence. One of the advantages of the preferred implementation of BIS is the Java-based platform independence that it offers. The BIS server and components are preferably (in 2002) completely implemented in the Sun Java Environment, as Java is (currently in 2002) the predominant language for creating portable, platform-independent software applications. The BIS environment preferably does not include any proprietary, natively-compiled libraries that must “link” with the Java environment. On the other hand, BIS can also have client connector or server provider capabilities on other platforms such as Microsoft Windows, in which case a native interface is preferably provided for non-Java (e.g., Microsoft VisualBasic, C#, C++, NET, COM) developers to access existing business object implemented in such other (e.g., Microsoft-) specific technologies.

In contrast, many Java-based solutions require the additional expense and internal expertise of a Java application server. An application server is a specialized software application that implements the business logic layer of a three-tier architecture. In the case of Java, application server generally refers to a full implementation of the Java 2 Platform, Enterprise Edition (J2EE) specification. The J2EE specification includes a web server and Enterprise Java Bean (EJB) server. While an application server is an important Internet application development environment, it is not a critical component for effective application integration. Moreover, its requirement in an integration server could indicate that, rather than providing a comprehensive integration technology, the server is—instead—simply leveraging techniques from the distributed application development architecture already included within existing application servers. An integration server that exposes these distributed application development techniques, in turn, exposes its customers to the same cost, complexity and risks of custom software development.

The BIS integration server, part of the comprehensive BIS integration environment, is not simply a “layer” on top of a Java application server. Rather, it is preferably a self-contained, software application that is focused on the unique technology problem of application integration. The preferred BIS environment thus requires only the existence of a JDK1.3-compliant Java Virtual Machine (JVM) on the host computer. JVM implementations are typically freely available for download via the Internet.

On the other hand, if an organization is already utilizing a Java Application Server for distributed application development, then BIS can leverage the clustering and fault-tolerance aspects of an application server for additional scalability. The evolutionary feature of BIS′ architecture: from a lightweight, self-contained installation, through leveraging the services of an enterprise database architecture, to a fully-implemented J2EE-compliant distribution allows BIS to solve an organization's integration issues with relevantly sized solutions.

Microsoft .NET/COM compatibility. While the BIS software written in Java does provide the most flexible deployment available in 2002, those skilled in the art will appreciate how it may be implemented in other platforms, including the new Microsoft .NET initiative. While BIS preferably includes native SOAP support, for the Microsoft .NET platform it does much more than simply provide a SOAP architecture. BIS preferably provides fully-compatible, natively-compiled interfaces for the connector (client-side) and provider (server-side) components. With these connection components, a Microsoft-based department or business partner can immediately take advantage of the same rapid integration environment as the Java developers. Thus, BIS delivers a solution that every business can use both internally and with there current and future partners, regardless of the application development technology each uses.

Where Sun has concentrated its efforts on increasing the portability of Java, Microsoft has chosen to make its various development languages (C++, VisualBasic, Fortran and, recently, C#) to be binary compatible. This is accomplished within the Microsoft .NET architecture with Common Language Runtime (CLR) objects. A CLR object is equally accessible from the various Microsoft development languages. BIS provides an abstract data binding mechanism that allows generated CLR objects to automatically integrate with the BIS environment.

Pluggable Server Components. The BIS integration solution preferably provides implementations of server-based tasks such as authentication, transport, logging and data binding. These implementations may be rooted in current best practices as established by enterprise, organizational and international developer communities. Many of these current approaches are still evolving and other, more vertically specialized, approaches have important implications for certain organizations. Rather than one-size-fits-all or tech-de-jour approaches to solving these issues of standards evolution, BIS complements best practice offerings with a “pluggable” server environment that allows customers to customize important server interfaces when appropriate.

Authentication: The question of authentication is important, complicated and significantly affected by the nature of particular integration projects. An integration solution that simply enables unification of two back-end server applications may require no additional authentication at all. Another integration project that exposes traditional mainframe capabilities to accessibility via the Internet might require a customized authentication layer for validating the sources and authorizations for integration requests.

Built in functionality: The preferred BIS integration server includes an internal authentication layer that is the default mechanism for determining who is authorized to access various integration operations. Those operations may, in turn, pass authentication information on to back-end applications. Alternatively, authentication can be governed simply by “gating” it through the internal mechanism and using a single authentication token to communicate with the integrated systems.

Operation-level authentication: Authentication within the preferred BIS environment is set at the operation level. That is, an individual who might have access to one type of information (for example, inventory levels) in a particular application might be excluded from other information (employee salaries). BIS has appropriate granularity to accurately respond to these distinctions.

LDAP/PKI/etc.: For many organizations, security is emerging as a top-priority for their information systems. These groups may have invested in sophisticated authentication solutions such as LDAP, PKI, or other centrally-managed user authentication systems. The BIS integration server can “pass-through” authentication requests to these architectures, enabling an organization to further leverage their investment in centralized rights administration.

Encryption: Security is not limited to directly obtaining access to information via compromised authentication. Another way to access data is to monitor the “raw” network traffic and look for particular data streams within that traffic. By default, much of the traffic on local networks and the Internet travels without any consideration of this threat. BIS software employs a variety of techniques, depending on the communication and integration needs of customers, to facilitate a securely encrypted transaction across the network or Internet. In addition to the currently popular use of the Secure Sockets Layer (SSL), available when using HTTP posts or other socket-based communication mechanisms, BIS also provides encryption when using other integration touch-points, such as manual submission, file system listeners, and integration through email. These additional encryption paths provide secure transmission, similar to the SSL approach, but route the encrypted data to the BIS server using non-HTTP transports. On the back-office implementation side of the request, an integration operation is simply invoked. The transport, authentication and encryption details are fully managed and resolved by the BIS server prior to instantiation of specific implementation code.

A particularly advantageous optional feature of BIS is what can be referred to as “one-click-security.” In this implementation, a convenient single GUI button is provided to the developer or administrator at an operational or set-up window 48. By clicking this button, a configuration is loaded into client code object indicating that operations and/or resources are to be authenticated and/or encrypted (step 6-2a); similar configuration is automatically performed at the solution server object and integration server. If desired, a skilled artisan could create several buttons to allow for more options or granularity (e.g., to select: security per single, multiple, or all operations; encryption and/or authentication separately; different types of security for differing users, roles, etc.). For purposes of simplicity of illustration a one-click-authentication embodiment is described following, but this could just as easily apply to other implementations employing multiple feature menus. Continuing, once configured the client code automatically signs the operations and/or resources when a job is prepared for transmission. In one convenient approach, each resource is separately signed by generating a digest of the resource and applying an MD5 algorithm (although any algorithm might be a candidate, and the full resource or other approach might also be applied, depending on design goals). If convenient, a public key approach may be used, allowing the client code to create its own public/private key and exchange such with the integration server; alternatively, a security monitor or certification authority can be used, or any other convenient approach that as a matter of design choice the organization's security administrator chooses to implement. However one chooses to implement this aspect, once signed the encrypted digest is then attached to the resource. After each resource is added to the operation, a similar process is repeated for the operation, i.e., creating a digest, encrypting it, and attaching the encrypted digest to the operation. (Step 6-3a). The signed operation or request is then forwarded to the integration server (step 6-3c). If desirable, the integration server could also sign timestamps with respect to each request and response (step 6-4c), omit signing for certain types of activities (e.g., only certain resources, or only operations), etc.

This preferred authentication process continues after the solution server 37 receives the data from the request(s)/operation(s) via the integration server (which, again, may be in the form of the original request, transformed into other desirable XML form via the integration server 36, or other desirable form/processing, and can include a further signing of the encapsulated data). This data is validated and/or decrypted by the solution server (step 6-6b), based on the data received and configuration information earlier stored. Alternatively, custom authentication/decryption via another authenticator/decryptor may be used (e.g., forwarding the information to another security subsystem) (step 6-6e). Operation start and complete times may also be signed (steps 67b, 6-11e). The response may similarly be signed by the solution server (6-11c) and later validated at the client code (step 6-14b).

While the preferred process just described includes a number of steps sufficient to implement a sophisticated security model, from an individual developer or administrator perspective it truly can be as easy as a one click implementation. In the preferred development suite a variety of security modules may be provided, or custom pluggable modules can be readily added via a convenient pluggable interface, each providing a predetermined security solution. For example, on the initial security set-up the security administrator could select, by way of illustration, an authentication type (MD5 digest hashing), encryption type (192 bit Rijndael), key parameters, etc. If multiple predetermined configurations are desirable, one could readily include multiple pre-selected buttons or other convenient selectable feature (e.g., button 1=basic authentication; button 2=basic authentication and encryption; button 3=strong-bit encryption and additional custom user/resource authentication code). This process can be preferably implemented in the form of an administrator screen 47 allowing the initial parameters to be set, as well as subsequent modification of the initial parameters (e.g., followed by an automatic configuration update for the integration server, solution server and client code). Once the desirable security parameters are thus selected/predetermined, other users with rights to create or modify operations need only concern themselves with whether a particular job or resource, or a superset of such, are to include authentication or encryption. As noted above, this process has simplified user interaction by allowing a given resource, operation, job set, etc. to be configured to automatically implement the predetermined security features associated with the button by means of as few as a single click or selection.

Transport: BIS may support a variety of transport technologies, such as:

SOAP: The Simple Object Access Protocol (SOAP) has received recent fanfare as the emerging standard for inter-application communications. It is a well-conceived mechanism for remote invocation of programmatic functionality and is fully supported within the BIS integration solution. BIS preferably employs SOAP exactly how it was conceived to be implemented—as a technique for building distributed applications. By thus employing SOAP connectivity within the BIS connector/server/provider host/provider communications path, the BIS objects communicate with each other using native SOAP calls (as a deployment option). Thus, BIS business integration users are able to leverage the strengths of SOAP without exposure to the complexities of interface, or custom data type, serialization.

HTTP: The well-established HyperText Transport Protocol (HTTP) is a popular mechanism for data transport due, mainly, to its extensive use as the primary means of communicating with Internet web sites. The billions of pages served daily with the HTTP protocol gives developers the confidence that the technology is well-vetted. Using HTTP “on top of” the Secure Sockets Layer (SSL), adds the additional value of secure data exchange. Again, BIS can utilize and support HTTP natively, but preferably provides classes for the implementation of HTTP connections to BIS integration operations. Thus, from the perspective of an implemented provider, a request is simply received and executed; information such as whether the operation was delivered via SOAP, HTTP, or secure HTTP is no longer important.

FTP: Another very well-supported protocol is the File Transport Protocol (FTP). One of the earliest protocols implemented on TCP/IP, FTP allows the transmission of both binary and text based (ASCII) data. An advantage of FTP is its broad support on older architectures that have not yet embrace SOAP and HTTP. Again, the selection of FTP as a transport within the BIS architecture is simply a server setting. Any integration operation available within the BIS solution is automatically accessible via FTP.

RMI/EJB/CLR/CORBA/DCOM: Again, while transport is important, it is currently a commodity within the software development community. The problem with application integration is not the result of a lack of Internet transport solutions. It is the result of: (1) the wrong code getting connected, and (2) different transport solutions being implemented on either end of the connectivity pipe. BIS provides native connections to all major distributed object technologies, including RMI, EJB, CLR, CORBA, and DCOM. BIS preferably encapsulates these transport and invocation calls within native business objects so that BIS users do not need to be expert distributed application developers to effectively deliver integrated enterprise software.

Logging: As with the other pluggable server components, integration operation logging is supported by the BIS integration solution. By providing a mechanism to override the default logging implementation, particular enterprises can employ different solutions for their own logging needs. For instance, one may remove the persistence of successful operations altogether, so that integration performance is maximized. Logging in different formats like a XML-data store is an additional option. Replicating logged data to legacy architectures, such as a Mainframe deployment, allows an additional accounting/tracking layer to be implemented to ensure the synchronization between systems remains accurate.

Data-binding: Data binding and, in particular, bound XML objects represents another component of a BIS integration solution. Because all processes and data in a preferred BIS environment are described and exchanged via XML documents, the programmed objects that are bound to these documents greatly reduce the effort necessary to implement an integration solution. By default, bound objects are preferably generated using the emerging JAXB standard from Sun Microsystems. However, since early adopters of XML-based technologies may have existing bound XML objects, BIS allows the use of these bound objects (Enhydra's ZEUS, for example) with a pluggable data-binding object that abstracts the methods necessary to stream and access data contained in XML documents.

User Interface. If the mantra for good real estate is “location, location, location,” then the corollary for integration software is “easy to use, easy to use, easy to use.” And the most obvious place for that ease of use to be demonstrated is the application user interface. The BIS user interface has an important distinction from many applications, in that it provides a variety of functions to very diverse constituencies: application developers, business process experts, business owners, consultants and quality assurance personnel. The user interface is designed with the diverse needs and technical capabilities of these constituencies in mind.

Web-based system interface: All functions within the preferred BIS integration solution are accessible via a web-based system interface. That is, once the BIS server is installed within an enterprise, subsequent access to integration solutions, tools, documentation, help system, reporting, testing and administration are accomplished via a standard Internet web browser. This lightweight approach to the user interface allows for sophisticated customization, immediate distributed project development, and remote access for consulting organizations and corporate IT resources.

Simple, managed interaction with system: Working with the BIS interface can be like browsing a website. Simple interfaces automate the most difficult integration tasks, such as remote deploying specialized Java packages. By following simple hyperlinks, business processes and data can be modeled, code generated to implement them, provider harnesses deployed to hand the requests, and specific provider implementations created to implement back-end application business logic.

Enforced business process methodology: As explained earlier in this document, the BIS architecture is more than simply a collection of technology solutions. It represents, rather, the cumulative application of proven integration methodologies into a preferably comprehensive integration environment. No matter how advanced an architecture or environment may be, however, it's success is largely dependent on its effective application to real-world business problems. The interface to the Business Integration System can guide all integration constituents through the process of identifying, modeling, developing, testing, deploying and maintaining software integration solutions. Rather than sidetracking developers with the ability to “push” back-end programmatic interfaces, it walks them through the simple steps needed to create flexible, abstract mechanisms for accomplishing these complex tasks.

Development Tools: The web-based user interface can also host and deliver on demand specialized integration tools that may greatly decrease the effort needed to create enterprise integration solutions. The tools can assist in all areas of the development process, including definition, development, deployment, and quality assurance.

Schema definition: During the definition phase of an integration solution based on the BIS architecture, business processes and related data are preferably modeled for exchange via XML documents. BIS provides an easy-to-use tool for creating XML Data Type Definitions and XML Schema Definitions as needed to specify integration operation constraints.

Code generation: Once defined as XML schemas, the code necessary to implement both client-side and server side functionality can be generated for native execution on Sun's Java Virtual Machine or Microsoft's Common Language Runtime (.NET architecture). The code generation capabilities are further customizable as a pluggable server component, so that existing generated objects can be used alongside new software development.

TestDriver prototyping tool: With the interfaced designed and code deployed to implement the integration operation, the user interface serves an automatic prototyping tool. A TestDriver application enables the ability to create, submit and view the results of an integration operation without programming. This rapid integration prototyping technique enables an organization to quickly prove out the value of the BIS environment without the introduction of costly proof-of-concept projects.

Dynamic Web-Form Generation: Once an integration solution is successfully deployed, access to particular operations may want to be accessed via human business processes. With dynamic web-form generation, any authorized remote user can be presented with a dynamically creating HTTP web form for manual creation of an integration operation request. The abstract nature of the BIS architecture can convert the request into an authenticated BIS request object, and the back-end application object is instantiated appropriately—with no code necessary to distinguish that the operation was initiated via a manual process.

Included Integration TouchPoints: Although most integration needs can be accomplished with programmatic or web-based integration connections, some solutions require more esoteric capabilities.

File system listener: For instance, an organization with a primarily manual environment might designate a particular file system directory as a target for copying time card reports. With the BIS solution, that directory can be monitored on a scheduled basis and the documents found there incorporated into legitimate integration request objects. Response, notification, and tracking of those objects can all be configured with operation-based server settings.

Email listener: Likewise, an organization may not have a sophisticated Internet presence, or might disable programmatic invocation across the firewall to address security issues. In this case, integration operations can still be developed, deployed and accessed via an email listener. The BIS email listener monitors a specific email account(s) for incoming integration operation documents. Then, just as in the case of the file system listener, appropriately authorized requests are converted into BIS integration request objects and are processed as part of the overall integration solution.

Broadcast/Publish-Subscribe listener: An additional capability, useful for many organizations, is the ability to broadcast integration operation requests or, alternatively, enable those requests via a publish-subscribe model. For instance, the accounting, human resources and intranet portal systems might all subscribe to the “NewEmployee” integration operation. When a new employee joins the organization, the systems would all receive the integration object that encapsulates the employee's information. The accounting system could set up payroll information, the human resources application could assign management responsibilities and coordinate benefit plans, and the corporate intranet could announce the employee's arrival to the rest of the organization. Subsequent additional applications could subscribe to the integration operation as well, such the processing of future employees might invoke additional services with no significant change to the corporate technology infrastructure.

Administration Capabilities. An integration architecture “sits” in the middle of enterprise software applications. Its administration should therefore be both powerful and flexible. Not only should it integrate applications, the integration server itself should be integrated into the organization's overall technology infrastructure. As a matter of practical lifecycle management, the architecture should allow for “hot” deployment of new implementations. That is, a new or modified set of programmatic functionality should not require the host server to be rebooted or the application itself to be “bounced”. The BIS solution provides these capabilities and couples them with specific integration functionality that can automate many common integration challenges:

Self-referencing integrated administration: The BIS environment publishes its configuration API using the same integration technologies it creates for its users. Thus, the administration of users, connectors, providers, transport settings, etc. are all accessible via programmatic objects, web interfaces, file system listeners, email listeners, etc. Using the same rapid integration techniques that one would employ to connect other systems together, the administration of BIS′ software may be seamlessly incorporated into a customer's technology infrastructure.

Hot-deployment: All integrated systems require eventual modification or enhancement. It is especially important for enterprise-critical systems to have the ability to be updated without experiencing “downtime” as the result of reloading configuration or operating system dependent registration information. BIS may include a version of the Java class loader that enables new functions to be added to the integration environment whether they are implemented natively in Java or in another development environment without requiring a configuration reload on the integration server or any deployed provider hosts.

Integration Functionality: In addition to integrated administration and hot-deployment capabilities, the BIS environment provides specific integration functionality that can be deployed via simple server configuration. Complex integration tasks such as comprehensive database transaction management, XML document translation, and ASCII report parsing can all be achieved via the user interface of the Business Integration System

SqlMapper: The BIS SqlMapper program provides a rapid mechanism for mapping XML integration operations to relation databases. Using a simple XML configuration file, all major database transactions are support: Create, Read, Update and Delete. Thus, for integration operation that do not require the inclusion of existing business object, but only the mapping to database transactions, SqlMapper includes a complete solution as a simple configuration document.

SchemaMapper: Combining the standards-based XSL mapping language with a BIS server object, SchemaMapper readily converts a document from one format to another. Whether differing XML vocabularies are being employed, or and EDI to XML translation is necessary, SchemaMapper automates the process and integrates it into the BIS technology infrastructure.

TreXml: Many older operating environments do not provide any modern integration interfaces: data source access, business objects, or XML support. For many of these, the only mechanism for accessing data is from the contents of text-based reports. The TreXml product is a server-side parser that can convert a text-based (ASCII) report into a well-formed XML document. Controlled by a simple XML configuration file, TreXml can process complex report documents and extract only the relevant date into an ordered XML document. This document can then be routed to an implemented provider to complete the integration operation.

Some of the advantages that BIS preferably offers Integration Service Providers and organizations needing integration include:

1. Increased efficiency and flexibility (and improved customer satisfaction) by: (a) Reducing the time to deploy one's applications; (b) Increasing the speed at which one's customer can go-to-market: (c) Making integration points more user-friendly, allowing non-programmers to use integration products like BIS; (d) Allowing one's customers to take ownership and maintain the integrated systems over time; and (e) Extending the value of one's customers' deployed networks.

2. Growing revenues and margins by one's: (a) Offering platform-independent integration between one's products and third party products used by one's customers; (b) Reducing one's own cost to deploy products; (c) Allowing one's “Non-programmel” implementers to deploy one's products; (d) Reducing one's own product development costs by reducing or eliminating the need for product-specific integration programming; and (e) Reducing one's product's time-to-market by reducing or eliminating the need to reconcile integration between products built on different platforms (i.e. Unix and Microsoft).

3. Improving attractiveness of one's products by: (a) Providing integration between one's own products and third party products; (b) Providing web services development and deployment capability for one's customer's use; (c) Adding enterprise integration capabilities to the solutions sold; and (d) Providing a standards-based, platform-independent, integration capability that reduces operating complexity and extends the life of one's applications.

4. Integration service vendors and system integrators are afforded a number of integration service opportunities through deployment of the BIS Portal by: (a) XML-based, platform-independent, integration between one's own products; (b) Integration between one's own products and third party products one's customer is using; (c) Integration between other products one's customer is using (customers can create integrations between own proprietary or purchased products); (d) Web access by one's customers to one s own products; (e) Interactive, web-based development environment for one's customers to access one's software via XML documents; and (t) Strengthening relationships with clients by offering a platform-independent integration solution, providing an integration capability that reduces operating complexity and extending the life of the solutions one builds and deploys.

While the foregoing constitute certain preferred and alternative embodiments of the present invention, it is to be understood that the invention is not limited thereto and that in light of the present disclosure, various other embodiments will be apparent to persons skilled in the art. Thus, for example, while the preferred embodiment is illustrated in connection with client server architectures and present (2002) computer environments, the invention may be used in any processing environment in which a variety of programs (whether software, firmware or the like) are used and some form of integration is desirable. Further, while the preferred embodiment has been described in terms of particular hardware and software, those skilled in the art will recognize how to implement various aspects of the invention in either hardware, software, or some combination of hardware and appropriately configured programs and processors implementing the described functionality, depending on the design choices that a skilled artisan may make. Accordingly, it is to be recognized that changes can be made without departing from the scope of the invention as particularly pointed out and distinctly claimed in the appended claims which shall be construed to encompass all legal equivalents thereof.

We claim:

1. An integration code for use in facilitating integration of plural application programs having different APIs, said integration code comprising a set of predetermined and fixed processes operable as a common API between said plural application programs.

2. The integration code of claim 1, wherein said processes comprise a predetermined job class and operation class forming a predetermined framework for requesting and receiving responses from an integration server.

3. The integration code of claim 2, further comprising a resource class operable to associate at least one dataset with an operation object, wherein the.

4. The integration code of claim 3, further comprising a connector class operable to create and manage job class objects.

5. The integration code of claim 4, wherein said job class is a java class having derivative request and responses classes operable to facilitate XML transactions between said plural application programs and said integration server.

6. A method for operating transactions between programs having different APIs which are at least partially incompatible, comprising:
a. creating an operation object including at least one dataset at a first program using a predetermined integration API;
b. submitting the operation object to an integration server;
c. processing the operation object to create a further request object including said dataset, and forwarding the request object to a solution program;
d. processing the request object by the solution program to extract the dataset and forward the dataset for processing at a second program according to functionality associated the operation object.

7. The method of claim 6, further comprising:
e. the solution program forming a response object including a response dataset from the second program;
f. processing the response object by the integration server and forwarding the response dataset to the first program.

8. The method of claim 7, wherein step d further comprises transaction management including commits of the type including one of the group of asynchronous/immediate, synchronous/immediate, asynchronous/deferred, and synchronous/deferred commits.

9. The method of claim 6, wherein step a further comprises creating the operation object at client code into a well-formed XML document

10. The method of claim 9, wherein step a further comprises creating the operation object with an XML document including bound objects.

11. A system for operating transactions between programs having different APIs which are at least partially incompatible, comprising:
an integration server having a predetermined and fixed API;
a first application having associated client code operably configured to create operations consistent with said API;
a second application having solution code operably configured to process data from said operations consistent with said API.

12. The system of claim 11, wherein the integration server further comprises an integration administrator operable to define operations, configure the client code and solution code, and log the processing of operations.

13. The system of claim 11, wherein the fixed API comprises predetermined operation, connector, and resource classes.

14. The system of claim 13, wherein the first application comprises a listener comprising at least one of the group of a file server listener, an email server listener, a publish-subscribe listener, and a broadcast listener, said at least one listener operable to monitor for and convert data of pre-selected characteristics into integration objects.

15. A process for integrating application programs having application interfaces which are at least partially incompatible, comprising:
a. initializing an integration administrator;
b. defining operations and operation resources for transactions between a client and target application programs;
c. configuring an integration server to accept transactions from the client application program via client code and from the target application via a solution server code;
d. configuring the client code consistent with a client application interface and a predetermined integration server API, and solution server code consistent with a target application interface and the integration server API;
e. deploying the client code and solution server code.

16. The process of claim 15, further comprising the integration administrator testing the integration by generating a sample request and verifying that a correct response is received from the target application.

17. The process of claim 15, wherein the integration administrator is a program element of an integration server, and step b further comprises receiving a user input selecting a first selectable item associated with a first predefined set of security parameters, and step e further comprises automatically deploying security functionality with the client code and solution server code operable to process operation data according to the type of security associated with said predefined set of security parameters.

18. A process for providing single-user-action implementation of security, comprising:
a. initializing an integration administrator operable to define operations consistent with a predetermined integration server API including an operation class, the integration administrator comprising a user interface have at least one selectable item associated with a predefined set of security parameters;
b. receiving a single user input selecting a first selectable item associated with a first predefined set of security parameters; and
c. automatically deploying security functionality so said operations are created and processed according to the type of security associated with said predefined set of security parameters.

19. The process of claim 18, wherein the type of security is message authentication, and step c comprises automatically configuring client code to digitally sign each operation and at least one of an integration server and target solution code to authenticate the digitally signed operation based on the predefined set of security parameters.

20. The process of claim 18, wherein the type of security is encryption, and step c comprises automatically configuring client code to encrypt operation data and at least one of an integration server and target solution code to decrypt the operation data based on the predefined set of security parameters.
